(19) United States
(12) Patent Application Publication
(10) Pub. No.: US 2009/0299234 A1
(43) Pub. Date: Dec. 3, 2009

(54) FAT REMOVER

(75) Inventor: SYUNG HYUN CHO, Seoul (KR)

Correspondence Address: CANTOR COLBURN, LLP, 20 Church Street, 22nd Floor, Hartford, CT, 06103, US

(73) Assignee: NUGA MEDICAL CO., LTD, Wonju-si (KR)

(21) Appl. No.: 12/128,350

(22) Filed: May 28, 2008

(51) Int. Cl. A61H 1/00

(52) U.S. Cl. 601/2

(57) ABSTRACT

A fat remover is disclosed, which comprises an upper main body including a plurality of connection terminals, a lower main body including an upper plate having a plurality of female rivets transmitting ultrasonic signals and low-frequency signals by contact with the connection terminals, a cup body having an opened bottom surface, a rubber plate interposed between the upper plate and the cup body, and a second lower plate inserted in the bottom surface of the cup body, and a skin contact sensor protruded on an inner lower part of the lower main body together with the ultrasonic vibration plate and the low-frequency vibration plate. Accordingly, the fat remover separately has the ultrasonic vibration plate and the low-frequency vibration plate, and performs fat removal after confirming a close contact between the skin and the vibration plates by the skin contact sensor, by applying stimulus to the skin contacting the vibration plates.

### BACKGROUND OF THE INVENTION

1. Field of the Invention

The present invention relates to a fat remover capable of removing fat of a fatty part of a body, and more particularly to a fat remover capable of properly removing subcutaneous fat accumulated under the fatty part by bringing an ultrasonic vibration plate and a low-frequency vibration plate into close contact with a skin of the fatty part using a negative pressure and generating ultrasonic waves and low-frequency waves.

2. Description of the Related Art

Owing to westernized diet and lack of exercise, obese patients have been increasing even in Korea regardless of gender and age. In order to improve such a tendency, many people are taking exercise to burn their fat and especially, some who are more seriously obese even use an apparatus generating ultrasonic waves to intensively remove the fat of fatty parts. Meanwhile, since low-frequency waves are proved also effective in improving dermal condition by properly stimulating the skin, a variety of apparatuses taking advantages of the ultrasonic waves and low-frequency waves have been researched and developed.

FIG. 1 shows a “Hand Fat Remover” disclosed in Korean Utility Model Registration No. 20-0353660. In the hand fat remover 100, a micro computer 250 installed in a main body 200 is controlled by a key switch 201 of an operation panel provided on an outside of the main body 200 having a bar-type handle form. Additionally, the hand fat remover 100 comprises an ultrasonic generating and output intensity adjusting unit 300 receiving signals from the micro computer 250 and transmitting the signals to an ultrasonic output terminal 301 and an ultrasonic output transmission line 302. The hand fat remover 100 further comprises a low-frequency generating and output intensity adjusting unit 400 connected to an ultrasonic transmission plate 401 and a low-frequency output transmission line 402, and a motor rotational intensity adjusting unit 500 determining rpm of a motor 502 which adjusts a vacuum pressure generated from a negative pressure generator 501.

More particularly, the main body 200 includes a suction cup 601 formed at one side, and a suction path 602 formed at an inside of the suction cup 601. After a user's skin is drawn in by the suction cup 601 to be brought into close contact with the ultrasonic transmission plate 401, the ultrasonic waves and the low-frequency waves are applied to stimulate the skin.

The conventional hand fat remover is inconvenient for a user to directly use in body parts such as belly or thighs since having an L-shape main body forming a long handle, where obesity rate is relatively high, due to the long handle. In addition, when the hand fat remover having a small size is applied to wide parts, the user's skin may be damaged by repetitive stimulation.

Moreover, since both the ultrasonic waves and the low-frequency waves are transmitted through one ultrasonic transmission plate, skin stimulating effect is deteriorated. Also, it is hard to know whether the skin is in good contact with the ultrasonic transmission plate. Therefore, treatment may be performed in a state where the contact between the skin and the ultrasonic transmission plate is not completed.

### SUMMARY OF THE INVENTION

Therefore, the present invention has been made in view of the above problems, and it is an object of the present invention to provide a fat remover having an ultrasonic vibration plate and a low-frequency vibration plate, which are operated only when a user's skin contacts a skin contact sensor and disposed inside a lower main body, to be capable of applying stimulus only to the skin caught in the lower main body.

It is another object of the present invention to provide a fat remover having a vertical posture and having a reduced diameter at an upper part of an upper main body for a user to conveniently grip the fat remover.

In accordance with the present invention, the above and other objects can be accomplished by the provision of a fat remover which breaks fat tissues by generating ultrasonic waves and low-frequency waves respectively by an ultrasonic vibration plate and a low-frequency vibration plate, the fat remover comprising an upper main body which includes a negative pressure motor connected with a first negative pressure pipe having a tube form and generating a negative pressure by a rechargeable battery mounted therein, a first lower plate including a lower protrusion connected with one side of the first negative pressure pipe and formed with a negative pressure hole and a fixing recess formed on an outer circumference of an inner recess to be mounted to a lower part of the upper main body, and a plurality of connection terminals connected with the rechargeable battery at a bottom surface of the first lower plate; a lower main body which includes an upper plate including a plurality of female rivets for transmitting the ultrasonic signals and the low-frequency signals in connection with the connection terminals and a first through-hole formed in the center of the lower main body for the lower protrusion to penetrate, a rubber plate closely contacting a lower part of the upper plate to keep airtightness and relieve a shock and including a first negative pressure hole for passage of the negative pressure and a second through-hole formed in the center for the ultrasonic vibration plate to penetrate, a cup body receiving the upper plate and the rubber plate at an upper surface thereof, having an opened bottom surface, and including a second negative pressure and a third through-hole respectively corresponding to the first negative pressure hole and the second through-hole, and a second lower plate including a third negative pressure hole and a fourth through-hole respectively corresponding to the second negative pressure hole and the third through-hole, a plurality of connection holes, and a plurality of male rivets engaged with the female rivets by being inserted in a lower part of the cup body; and a skin contact sensor inserted in the connection holes of the second lower plate, being arranged across the low-frequency vibration plate, so as to detect contact of the skin.

The upper main body may have a reduced diameter at an upper part thereof for a user to conveniently grip the fat remover.

The lower main body may be removably mounted by having a first fixing protrusion inserted in the fixing recess formed at the first lower plate of the upper main body.

The cup body may be formed by injection molding of glass or synthetic resin.

The fat remover may further comprise a mounting frame including a second fixing protrusion inserted in the fixing recess of the first lower plate of the upper main body so that the upper main body is removably connected to the mounting frame.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view of a conventional hand fat remover;

FIG. 2 is a perspective view of a fat remover according to an embodiment of the present invention;

FIG. 3 is an exploded view of the fat remover according to the embodiment of the present invention;

FIG. 4 is a detailed sectional view showing a lower main body of the fat remover according to the embodiment of the present invention;

FIG. 5 is a bottom view of the lower main body of the fat remover according to the embodiment of the present invention; and

FIG. 6 shows the fat remover according to the embodiment of the present invention, as stowed in a mounting frame when not in use.

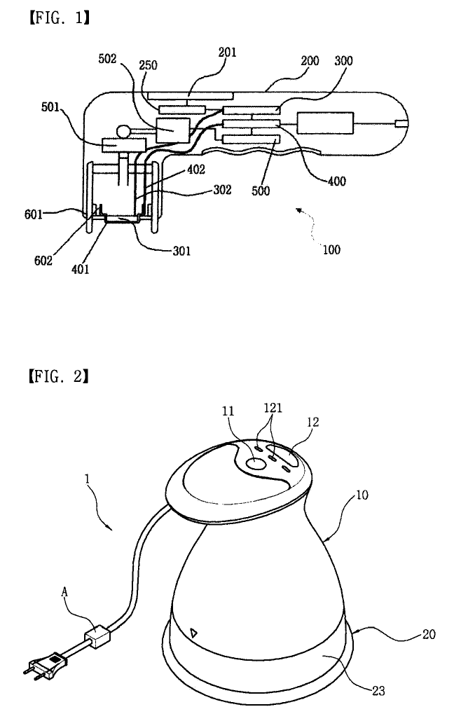

### DETAILED DESCRIPTION OF THE PREFERRED EMBODIMENTS

Hereinafter, an exemplary embodiment of the present invention will be described in detail with reference to the accompanying drawings.

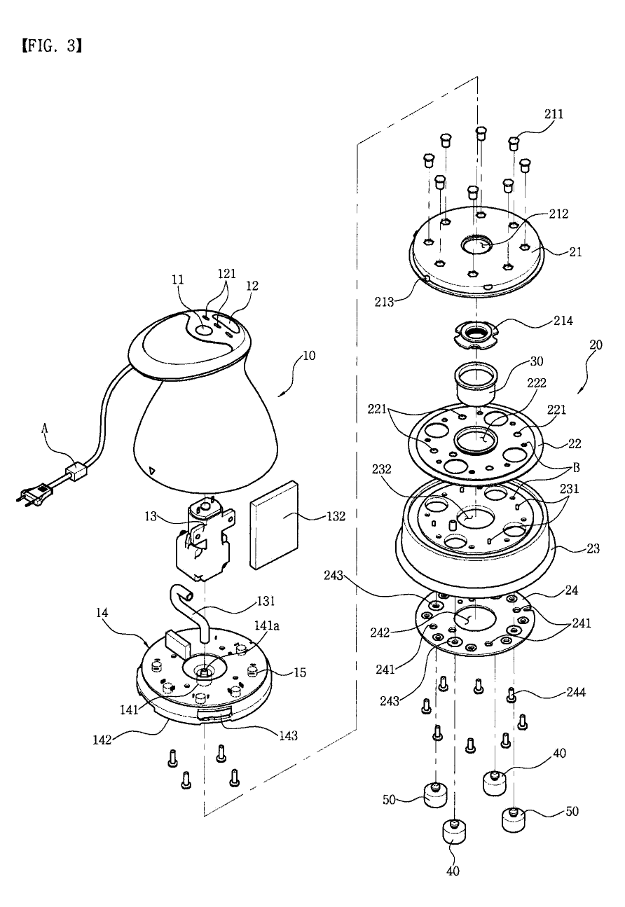

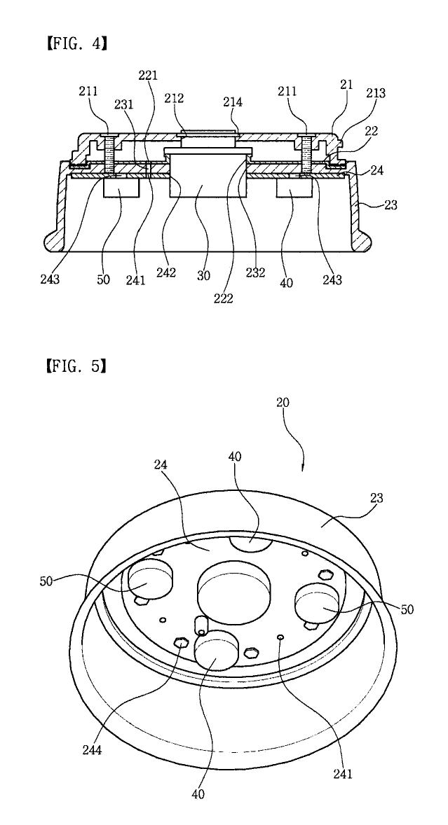

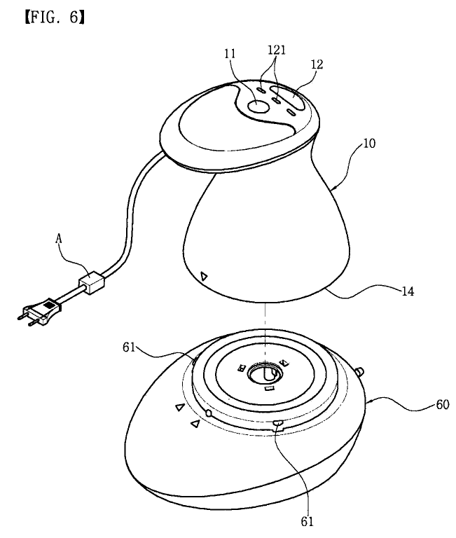

FIG. 2 is a perspective view of a fat remover according to an embodiment of the present invention, FIG. 3 is an exploded view of the fat remover, FIG. 4 is a detailed sectional view showing a lower main body of the fat remover, and FIG. 5 is a bottom view of the lower main body of the fat remover. FIG. 6 shows the fat remover according to the embodiment of the present invention, as stowed in a mounting frame when not in use. A reference numeral 1 denotes the fat remover according to the embodiments of the present invention.

The fat remover 1 comprises an upper main body 10 including a power unit 11 applying electric power and an adjusting unit 12 adjusting intensity of ultrasonic waves and low-frequency waves, the power unit 11 and the adjusting unit 12 formed on an upper surface thereof, and a lower main body 20 connected to a lower part of the upper main body 10 and brought into close contact with a human skin by an opened lower part thereof. The fat remover 1 also comprises an ultrasonic vibration plate 30 protruded from an inner lower center of the lower main body 20 to generate ultrasonic waves, a pair of low-frequency vibration plates 40 protruded on positions outer than the ultrasonic vibration plate 30 and arranged to face each other horizontally, a pair of skin contact sensors 50 protruded on positions outer than the ultrasonic vibration plate 30 to face each other horizontally and arranged across the pair of low-frequency vibration plates 40, and a mounting frame 60 receiving and fixing the upper main body 10.

As shown in FIG. 3, the upper main body 10 has a diameter decreasing partly toward an upper end thereof so that a user can conveniently hold the upper main body by one or both hands.

More particularly, the upper main body 10 includes the power unit 11 applying electric power to the fat remover 1, the adjusting unit 12 disposed next to the power unit 11 to adjust intensity of the ultrasonic waves and low-frequency waves, a negative pressure motor 13 disposed in the upper main body 10 in connection with one side of a first negative pressure pipe 131 transmitting a negative pressure therethrough, and operated by a rechargeable battery 132 to generate the negative pressure, a first lower plate 14 which includes a lower protrusion 141 protruding downward and having a negative pressure hole 141a formed through the center thereof and connected to the other side of the first negative pressure pipe 131, and fixing recesses 143 formed on an outer circumference of an inner recess 142, and a plurality of connection terminals 15 formed on a bottom surface of the first lower plate 14 and connected with the rechargeable battery 132.

The adjusting unit 12 is equipped with a state indicating lamp 121 to let a user recognize a power application state and intensity of the ultrasonic waves and the low-frequency waves being adjusted.

The negative pressure hole 141a is formed through the center of the first lower plate 14. The first negative pressure pipe 131 is connected to the negative pressure hole 141a at an upper surface of the lower plate 14.

Referring to FIG. 4 and FIG. 5, the lower main body 20 is constituted by placing an upper plate 21 and a rubber plate 22, having a disc form, on an upper part of a cup body 23 sequentially so that the upper plate 21, the rubber plate 22 and the cup body 23 are in close contact with one another. A second lower plate 24 is inserted in the opened lower part of the cup body 23. Additionally, male rivets 244 of the second lower plate 24 are inserted in female rivets 211 of the upper plate 21, thereby achieving rivet-connection.

Also, the lower main body 20 is separably mounted by having a plurality of first fixing protrusions 213 formed along an outer circumference of an upper part of the upper plate 21 and inserted in the fixing recess 143.

The female rivets 211 are fixedly inserted in rivet holes B formed on an upper surface of the upper plate 21, thereby forming contact points with the connection terminals 15 to transmit electric signals to the ultrasonic vibration plate 30 and the low-frequency vibration plate 40. The lower protrusion 141 is inserted in a first through-hole 212 formed in the center of the upper plate 21. In addition, an O-ring 214 is inserted to hermetically maintain the negative pressure.

The rubber plate 22 includes a plurality of first negative pressure holes 221_such that air in the cup body 23 can be drawn in by the negative pressure generated in the negative pressure hole 141a. The rubber plate 22 also includes a second through-hole 222 in the center thereof. After the ultrasonic vibration plate 30 is inserted in the second through-hole 222, the upper plate 21 is brought into close contact with an upper surface of the rubber plate 22. Thus, the rubber plate 22 keeps airtightness between the upper plate 21 and the cup body 23.

The cup body 23 comprises second negative pressure holes 231 and a third through-hole 232 at corresponding positions to the first negative pressure holes 221 and the second through-hole 222, respectively. The cup body 23 may be made of glass or synthetic resin appropriate for close contact with the skin and safe against electricity. A bottom surface of the cup body 23 may be processed in various shapes.

The second lower plate 24 has third negative pressure holes 241 and a fourth through-hole 242 corresponding to the second negative pressure holes 231 and the third through-hole 232, respectively. Connection holes 243 are formed on positions outer than the fourth through-hole 242. The low-frequency vibration plate 40 and the skin contact sensor 50 are inserted in the connection holes 243 respectively in pairs. As the male rivets 244 inserted in the female rivets 211 are inserted in the rivet holes B, rivet-connection through the upper plate 21, the rubber plate 22, the cup body 23 and the second lower plate 24 is achieved.

The mounting frame 60 fixes the upper main body 10. To this end, the mounting frame 60 includes second fixing protrusions 61 that will be inserted in the fixing recesses 143.

Hereinafter, how the above-structured fat remover 1 is used and operated will be explained.

As shown in FIG. 2, the fat remover 1 is driven by the rechargeable battery 132 mounted in the upper main body 10. Also, the fat remover 1 may be used in general homes using a general adaptor A that directly recharges or supplies power to the fat remover 1.

When the fat remover 1 is used in a fatty part, the lower main body 20 is connected to the upper main body 10. More specifically, the lower main body 20 including the ultrasonic vibration plate 30 and the low-frequency vibration plate 40 is connected as the plurality of first fixing protrusions 213 formed on the outer circumference of the upper plate 21 are inserted in the fixing recesses 143 of the first lower plate 14.

The fat remover 1 is operated upon power application through the power unit 11 formed on the upper surface of the upper main body 10. When the adjusting unit 12 is pushed, the negative pressure motor 13 is operated, thereby drawing the skin into the cup body 23 by drawing in the air existing in the cup body 23 through the first negative pressure pipe 131, the negative pressure hole 141a, and the first to the third negative pressure holes 221, 231 and 241 formed at the lower main body 20.

More specifically, the lower main body 20 is constituted by the upper plate 21 and the cup body 23, and the rubber plate 22 interposed between the upper plate 21 and the cup body 23 for airtightness and shock relief. The second lower plate 24 is inserted in the bottom surface of the cup body 23 so that the female rivets 211 and the male rivets 244 are connected with each other. The lower protrusion 141 is inserted in the first through-hole 212 of the upper plate 21. The ultrasonic vibration plate 30 is inserted in and fixed to the second through-hole 222 of the rubber plate 22, the third through-hole 232 of the cup body 23, and the fourth through-hole 242 of the second lower plate 24.

By the insertion of the lower protrusion 141a, a path for movement of the negative pressure is formed through the first negative pressure hole 221, the second negative pressure hole 231 and the third negative pressure hole 241. Therefore, the air inside the cup body 23, which is in close contact with the skin, is drawn in upward by the negative pressure operated through the path. As a result, the skin is drawn in and brought into close contact with the ultrasonic vibration plate 30, the low-frequency vibration plate 40, and the skin contact sensor 50.

Upon contact of a skin tissue of the fatty part with the skin contact sensor 50, the negative pressure motor 13 is stopped, and the connection terminals 15 connected with the rechargeable battery 132 in the inner recess 142 formed at the lower part of the first lower plate 14 or connected with the adapter A achieve contact points with the female rivets 211 of the upper plate 21. Thus, transmission of ultrasonic signals and low-frequency signals is enabled such that stimulus can be applied to the skin tissue through the ultrasonic vibration plate 30 and the low-frequency vibration plate 40.

The intensity of the ultrasonic waves and the low-frequency waves can be adjusted through the adjusting unit 12. Here, during use of the fat remover 1, the user can recognize the intensity levels indicated by the state indicating lamp 121.

As shown in FIG. 6, when the fat remover 1 is not in use, the upper main body 10 is stowed in the mounting frame 60. More specifically, the upper main body 10 can be removably connected to the mounting frame 60 as the plurality of second fixing protrusions 61 formed at an upper part of the mounting frame 60 are inserted in the fixing recesses 143 formed at the inner recess 142 of the first lower plate 14.

As described above, the fat remover according to the embodiment of the present invention separately has an ultrasonic vibration plate and a low-frequency vibration plate, and performs fat removal after confirming that a close contact is achieved between skin and the vibration plates by a skin contact sensor, by applying stimulus to the skin contacting the vibration plates. When not in use, the fat remover can be conveniently stowed by separating a lower main body and connecting an upper main body to a mounting frame.

In addition, because the lower main body having a wide form is separable and the upper main body has a reduced diameter at an upper part thereof, the user can hold the fat remover conveniently.

As apparent from the above description, the present invention provides the fat remover capable of being applied by a wide area of a user's body by having the widely formed lower main body, being conveniently gripped by the user since having a reduced diameter at an upper part of the upper main body, and more effectively removing the fat by applying stimulus to the skin only upon contact of the skin with the ultrasonic vibration plate and the low-frequency vibration plate by using the skin contact sensor.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A fat remover which breaks fat tissues by generating ultrasonic waves and low-frequency waves respectively by an ultrasonic vibration plate and a low-frequency vibration plate, the fat remover comprising:
an upper main body which includes a negative pressure motor connected with a first negative pressure pipe having a tube form and generating a negative pressure by a rechargeable battery mounted therein, a first lower plate including a lower protrusion connected with one side of the first negative pressure pipe and formed with a negative pressure hole and a fixing recess formed on an outer circumference of an inner recess to be mounted to a lower part of the upper main body, and a plurality of connection terminals connected with the rechargeable battery at a bottom surface of the first lower plate;
a lower main body which includes an upper plate including a plurality of female rivets for transmitting the ultrasonic signals and the low-frequency signals in connection with the connection terminals and a first through-hole formed in the center of the lower main body for the lower protrusion to penetrate, a rubber plate closely contacting a lower part of the upper plate to keep airtightness and relieve a shock and including a first negative pressure hole for passage of the negative pressure and a second through-hole formed in the center for the ultrasonic vibration plate to penetrate, a cup body receiving the upper plate and the rubber plate at an upper surface thereof, having an opened bottom surface, and including a second negative pressure and a third through-hole respectively corresponding to the first negative pressure hole and the second through-hole, and a second lower plate including a third negative pressure hole and a fourth through-hole respectively corresponding to the second negative pressure hole and the third through-hole, a plurality of connection holes, and a plurality of male rivets engaged with the female rivets by being inserted in a lower part of the cup body; and
a skin contact sensor inserted in the connection holes of the second lower plate, being arranged across the low-frequency vibration plate, so as to detect contact of the skin.

2. The fat remover according to claim 1, wherein the upper main body has a reduced diameter at an upper part thereof for a user to conveniently grip the fat remover.

3. The fat remover according to claim 1, wherein the lower main body is removably mounted by having a first fixing protrusion inserted in the fixing recess formed at the first lower plate of the upper main body.

4. The fat remover according to claim 1, wherein the cup body is formed by injection molding of glass or synthetic resin.

5. The fat remover according to claim 1, further comprising a mounting frame including a second fixing protrusion inserted in the fixing recess of the first lower plate of the upper main body so that the upper main body is removably connected to the mounting frame.
